(19) United States
(12) Patent Application Publication
(10) Pub. No.: US 2008/0185062 A1
(43) Pub. Date: Aug. 7, 2008

(54) FLUID CONTROL VALVE

(76) Inventor: PETER LODEWIJK JOHANNES NIJLAND, Losser (NL)

Correspondence Address: JENSEN + PUNTIGAM, P.S., SUITE 1020, 2033 6TH AVE, SEATTLE, WA, 98121, US

(21) Appl. No.: 11/671,335

(22) Filed: Feb. 5, 2007

(51) Int. Cl. F16K 15/14

(52) U.S. Cl. 137/854

(57) ABSTRACT

The invention relates to a fluid control value, such as an umbrella valve (40), to be inserted in a valve housing (140), said valve comprising a sealing element (44) having a sealing surface and projecting in a radial direction for sealing one or more fluid openings (145) in said valve housing, which sealing element is responsive to fluid pressure to open and close to control the fluid flow through the fluid openings. The sealing element is provided with at least one recess (47) on the surface of the sealing element such that at least one sealing end (45) is defined on the sealing element extending between the recess and the periphery of the sealing element, said sealing end carrying the sealing surface. The fluid control valve according to the invention is an excellent pressure relieve valve allowing a large flow at a high opening pressure.

### TECHNICAL FIELD

The present invention relates to a fluid control valve to be inserted in a valve housing, said valve comprising a sealing element having a sealing surface and projecting in a radial direction for sealing one or more fluid openings in said valve housing, which sealing element is responsive to fluid pressure to open and close to control the fluid flow through the fluid openings.

### BACKGROUND ART

A known example of a fluid control valve is an umbrella valve or an inverted umbrella valve. An (inverted) umbrella valve typically has an integral stem by which it is normally attached in a preloaded position of closure. A sealing element is attached to the stem and is deflectable in response to differential pressure to assume an open position permitting forward flow there past, once the differential pressure reaches a certain opening pressure. When the differential pressure acting in this direction is relieved or when the differential pressure acts in the opposite direction such as on the occurrence of a backward flow, the elastomeric (inverted) umbrella valve because of its preload assumes its normally closed position and so prevents further forward flow as well as flow in the reverse or backward direction with the preload then assisted by the back pressure.

### DISCLOSURE OF THE INVENTION

It is an object of the invention to provide a fluid control valve as mentioned above having improved flow characteristics in the direction of forward flow while maintaining a fluid-tight seal until opening as well as in the reverse or backward direction.

According to the present invention this object is achieved by the fluid control valve according to the preamble, characterized in that, the sealing element is provided with at least one recess on the surface of the sealing element such that at least one sealing end is defined on the sealing element extending between the recess and the periphery of the sealing element, said sealing end including the sealing surface.

The technical measures of providing a recess on the surface of the sealing element of the valve allows the sealing end with the sealing surface to be moved farther from the seat of the valve housing thus allowing a greater flow when the differential pressure reaches the opening pressure and the fluid control valve assumes its open position. At the same time the sealing end will have a more stable form, which allows a higher preload leading to a higher opening pressure while maintaining a larger flow. Amongst many other applications these characteristics render the fluid control valve according to the invention very suitable as a pressure relieve valve.

According to a first preferred embodiment the sealing end comprises a thickened part located adjacent the recess. The dimension of the thickened part influences the value of the opening pressure of the fluid control valve. For each application a thickened part having a suitable dimension can be chosen.

In an advantageous preferred embodiment the recess is substantially located in the center of the sealing element. Consequently the dimensions of the sealing end and thus of the sealing surface may then be maximal.

In a first practical embodiment the recess is substantially disc-shaped. In a second practical embodiment the recess is a groove forming an essentially closed loop. Preferably the groove has a substantially annular shape.

In a more elaborate preferred embodiment the sealing element is provided with two or more grooves extending over the surface of the sealing element at a predetermined mutual distance between subsequent grooves. The sealing end is divided in sub-ends by the additional groove(s) that are movable relative to each other thus allowing the sealing end to deflect under fluid pressure while the sub-ends themselves have a rather stable form.

In an elegant embodiment the sealing element has a substantially disc shape.

These and other features and advantages of the invention and reference to the associated drawings.

### BRIEF DESCRIPTION OF THE DRAWINGS

The invention will be explained in more detail with reference to the appended drawings, in which:

FIG. 1A shows a first preferred embodiment of a fluid control valve according to the invention in a closed position;

FIG. 1B shows the first preferred embodiment of FIG. 1A in an open position;

FIG. 2A shows a second preferred embodiment of a fluid control valve according to the invention in a closed position;

FIG. 2B shows the second preferred embodiment of FIG. 2A in an open position;

FIG. 3A shows a third preferred embodiment of a fluid control valve according to the invention in a closed position;

FIG. 3B shows the third preferred embodiment of FIG. 3A in an open position;

FIG. 4A shows a fourth preferred embodiment of a fluid control valve according to the invention in a closed position;

FIG. 5A shows a fifth preferred embodiment of a fluid control valve according to the invention in a closed position;

FIG. 5B shows the fifth preferred embodiment of FIG. 5A in an open position;

FIG. 6A shows a sixth preferred embodiment of a fluid control valve according to the invention in a closed position;

FIG. 6B shows the sixth preferred embodiment of FIG. 6A in an open position;

FIG. 7A shows a seventh preferred embodiment of a fluid control valve according to the invention in a closed position;

FIG. 7B shows the seventh preferred embodiment of FIG. 7A in an open position;

FIG. 8 shows a curve illustrating the improvement of the fluid control valve according to the invention over the prior art.

### BEST MODE FOR CARRYING OUT THE INVENTION

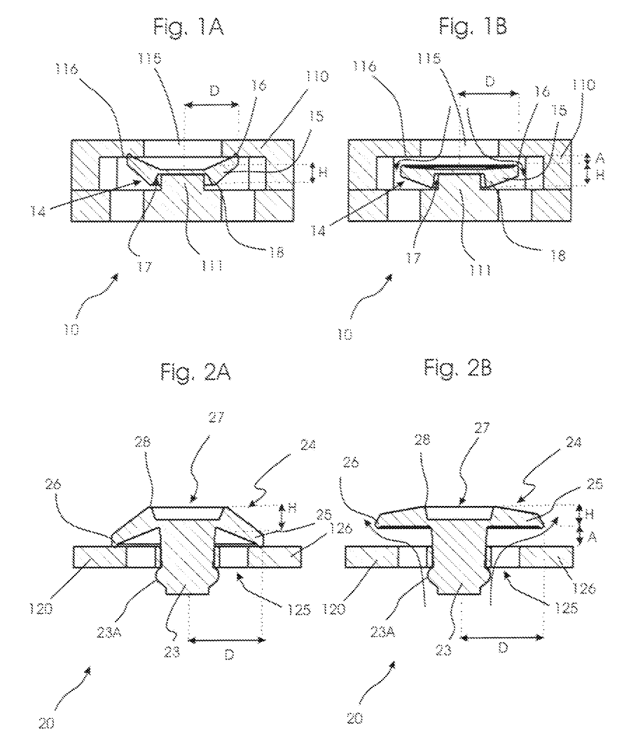

FIG. 1A shows a cross-sectional view of a first preferred embodiment of a fluid control valve 10 according to the invention in a closed position. FIG. 1B shows a cross-sectional view of fluid control valve 10 in an open position.

Fluid control valve 10 is to be inserted against a support 111 in a valve housing 110 that is schematically shown in part. Fluid control valve 10 controls the fluid flow through the valve housing 110. The direction of fluid flow is indicated by the arrows in FIG. 1B. In the preferred embodiment shown valve 10 comprises a valve body consisting of a sealing element 14 that projects in radial direction forming a sealing surface for sealing the fluid openings 115 that are present in valve housing 110. The sealing element is provided with at least one recess 17 located in the center of the surface of the sealing element 14. The sealing end 15 is present between the recess 17 and the periphery of the sealing element 14. The sealing surface is formed by the bottom surface of the sealing end 15 as seen in the direction of fluid flow. In the closed position shown the tip 16 of the sealing end 15 touches the seat 116 of the valve housing thereby sealing off the fluid openings 115.

In the embodiment shown the recess 17 is located on the upper surface of the sealing element as seen in the direction of fluid flow. Typically the shape of the recess 17 will be in conformance with the shape of the outer circumference of the sealing element 14. Typically valve 10 has a disc or dish shaped sealing element and the recess 17 has a generally round shape.

Adjacent the recess 17 the sealing end 15 comprises a thickened part 18. The ratio of the height H of the thickened or bulging part 18 to the diameter D of the sealing disc is one of the design parameters to determine the opening pressure of the valve 10.

Once the pressure difference over the valve housing 110 is sufficiently high, the sealing element is forced to its open position shown in FIG. 1B. The sealing surface is lifted off of the seat 116 of the valve housing 110 allowing the fluid to flow through the fluid openings 115. The flow will be relatively large, since the distance A between the sealing surface and the seat is relatively large due to the recess 17.

FIG. 2A shows a cross-sectional view of a second preferred embodiment of a fluid control valve 20 according to the invention in closed position. FIG. 2B shows a cross-sectional view of fluid control valve 20 in open position.

Fluid control valve 20 is equal to fluid control valve 10 shown in FIGS. 1A and 1B provided with a stem 23. All reference numerals in FIGS. 2A and 2B are incremented with 10 when compared to the reference numerals of FIGS. 1A and 1B denoting equal parts.

In the preferred embodiment shown valve 20 is an umbrella valve. Umbrella valve 20 comprises a stem 23 for positioning the valve in a stem opening of the valve housing 120. The stem 23 is provided with a bulbous part 23A for securing the stem in the stem opening. A sealing element 24 is connected to one end of the stem 23. Sealing element 24 projects beyond the stem 23 in radial direction.

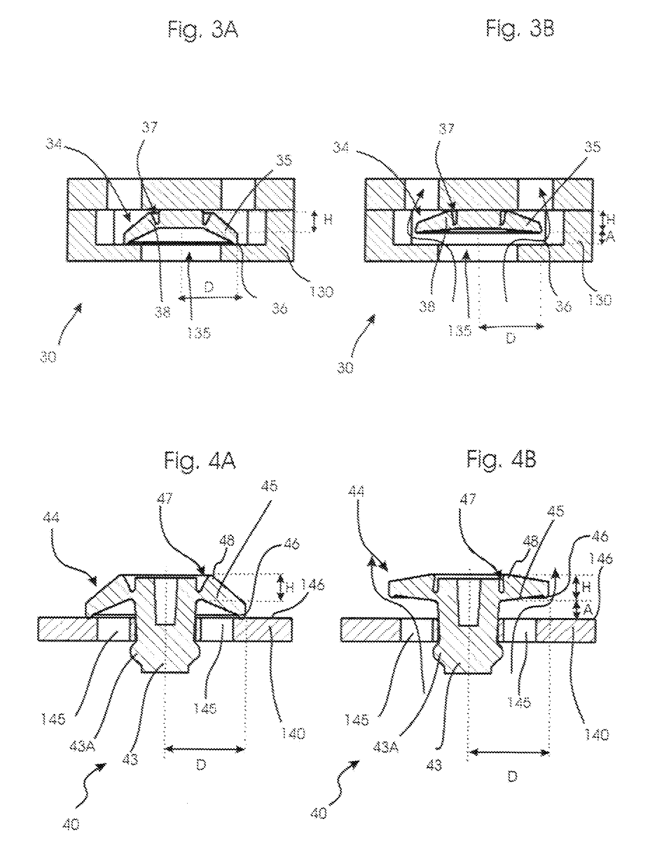

FIG. 3A shows a cross-sectional view of a third preferred embodiment of a fluid control valve 30 according to the invention in closed position. FIG. 3B shows a cross-sectional view of fluid control valve 30 in open position.

Fluid control valve 30 is similar to fluid control valve 10 shown in FIGS. 1A and 1B. The main difference resides in the fact that the recess is formed by a groove 37. All reference numerals in FIGS. 3A and 3B are incremented with 20 when compared to the reference numerals of FIGS. 1A and 1B denoting equal parts.

The sealing element 34 is provided with at least one groove 37 extending over the surface of the sealing element 34. The sealing end 35 is present between the groove 37 and the periphery of the sealing element 34.

In the third embodiment shown the groove 37 is located on the upper surface of the sealing element as seen in the direction of fluid flow. Furthermore the groove 37 is located in the center of the sealing element 34. Typically valve 30 has a disc or dish shaped sealing element. Typically the shape of the groove 37 will be in conformance with the shape of the outer circumference of the sealing element 34. Typically valve 30 has a disc or dish shaped sealing element and the groove 37 has a generally annular shape.

FIG. 4A shows a cross-sectional view of a fourth preferred embodiment of a fluid control valve 40 according to the invention in closed position. FIG. 4B shows a cross-sectional view of fluid control valve 40 in open position.

Fluid control valve 40 is equal to fluid control valve 30 shown in FIGS. 3A and 3B provided with a stem 43. All reference numerals in FIGS. 4A and 4B are incremented with 10 when compared to the reference numerals of FIGS. 3A and 3B denoting equal parts.

In the preferred embodiment shown valve 40 is an umbrella valve. Umbrella valve 40 comprises a stem 43 for positioning the valve in a stem opening of the valve housing 140. The stem 43 is provided with a bulbous part 43A for securing the stem in the stem opening. A sealing element 44 is connected to one end of the stem 43. Sealing element 44 projects beyond the stem 43 in radial direction. Sealing element 44 projects beyond the stem 43 in radial direction forming a sealing surface for sealing the fluid openings 145 that are present in valve housing 140.

The sealing element is provided with at least one groove 47 extending over the surface of the sealing element 44 as a closed loop. The sealing end 45 is present between the groove 47 and the periphery of the sealing element 44. The sealing surface is formed by the bottom surface of the sealing end 45 as seen in the direction of fluid flow. In the closed position shown the tip 46 of the sealing end 45 touches the seat 146 of the valve housing thereby sealing off the fluid openings 145.

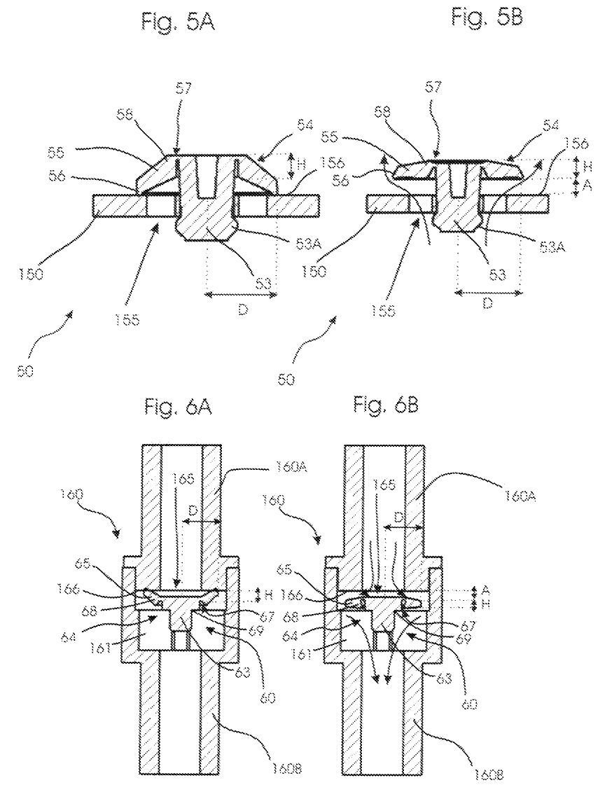

FIG. 5A shows a cross-sectional view of a fifth preferred embodiment of a fluid control valve 50 according to the invention in closed position. FIG. 5B shows a cross-sectional view of fluid control valve 50 in open position.

Fluid control valve 50 is similar to fluid control valve 40 shown in FIGS. 4A and 4B. The only difference can be found in the position of the groove 57 which extends on the bottom surface of the sealing element 54. All reference numerals in FIGS. 5A and 5B are incremented with 10 when compared to the reference numerals of FIGS. 4A and 4B denoting equal parts.

FIG. 6A shows a cross-sectional view of a sixth preferred embodiment of a fluid control valve 60 according to the invention in closed position. FIG. 6B shows a cross-sectional view of fluid control valve 60 in open position.

Fluid control valve 60 is to be inserted in a valve housing 160 that is schematically shown in cross section. The valve housing 160 comprises two matching part 160A and 160B. Fluid control valve 60 controls the fluid flow in one direction through the valve housing 160. The direction of fluid flow is indicated by the arrows in FIG. 6B. In the preferred embodiment shown valve 60 is an inverted umbrella valve. Inverted umbrella valve 60 comprises a stem 63 for positioning the valve in a support 161 of the valve housing 160. The stem 63 is provided with a shoulder 69 abutting against the support 161. A sealing element 63 in radial direction forming a sealing surface for sealing the fluid openings 165 that are present in the seat 166 of the valve housing 160. The sealing element is provided with at least one groove 67 extending over the surface of the sealing element 64 in a closed loop. The sealing end 65 is present between the groove 67 and the periphery of the sealing element 64. The sealing surface is formed by the bottom surface of the sealing end 65 as seen in the direction of fluid flow. In the closed position shown the tip of the sealing end 65 touches the seat 166 of the valve housing thereby sealing off the fluid openings 165.

In the embodiment shown the groove 67 is located on the upper surface of the sealing element as seen in the direction of fluid flow. Furthermore the groove 67 is located in the vicinity of the stem 63 even surrounding the stem 63. Typically an inverted umbrella valve has a disc shaped sealing element. Typically the shape of the groove 67 will be in conformance with the shape of the sealing element. In the case of a sealing disc the groove 67 has a generally annular shape.

Adjacent the groove 67 the sealing end 65 comprises a thickened part 68. The ratio of the height H of the thickened or bulging part 68 to the diameter D of the sealing disc determines the opening pressure of the valve 60.

Once the pressure difference over the compartments 160A and 160B of the valve housing 160 is sufficiently high, the sealing element is forced to its open position shown in FIG. 6B. The sealing surface is lift of the seat 166 of the valve housing 160 allowing the fluid to flow through the fluid openings 165. The flow will be relatively large, since the distance A between the sealing surface and the seat is relatively large due to the groove 67.

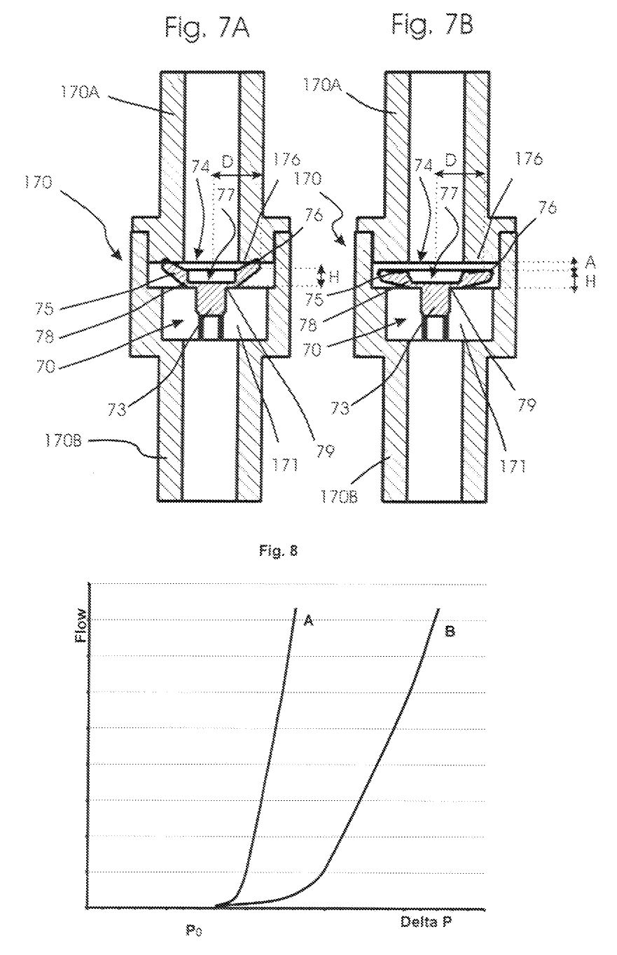

FIG. 7A shows a cross-sectional view of a seventh preferred embodiment of a fluid control valve 70 according to the invention in closed position. FIG. 7B shows a cross-sectional view of fluid control valve 70 is open position.

Fluid control valve 70 is similar to fluid control valve 60 shown in FIGS. 6A and 6B. Inverted umbrella valve 70 is provided with a recess 77. The recess is present at the bottom surface of the sealing element 74 as seen in the direction of fluid flow. All reference numerals in FIGS. 7A and 7B are incremented with 10 when compared to the reference numerals of FIGS. 6A and 6B denoting equal parts. The recess 77 has a similar shape and position as recess 17 in FIGS. 1A, 1B and recess 27 in FIGS. 2A, 2B.

Preferably the fluid control valve according to the invention is made of a suitable elastomeric material, such as thermoset or thermoplastic rubber.

FIG. 8 shows a diagram illustrating the improvement of the fluid control valve according to the invention over the prior art. The diagram illustrates the relation between the flow (on the vertical axis) and the differential pressure over the seat of the valve housing (on the horizontal axis). Line A shows this relation for a fluid control valve according to the invention. Line B shows this relation for a fluid control valve according to the prior art. Advantageously the fluid control valve according to the invention allows a greater flow at equal pressure. This is due to the presence of the recess. By removing material from the sealing element to shape the recess a flexible area is created that functions as a swivel point or hinge for the sealing end. The opening pressure P among others can be determined by choosing the ratio H/D.

In the preferred embodiments provided with a groove the effect of the groove may be enhanced by providing the sealing element with two or more grooves extending over the surface of the sealing element at a predetermined mutual distance between subsequent grooves. Preferably the grooves form closed loops surrounding each other.

It is noted that the preferred embodiments shown and described in the figures can be combined and that all these combinations fall within the scope of the present invention.

The fluid control valve according to the invention is in general suitable for controlling fluid flow through a valve housing and may be applied in all kinds of apparatus in various technical fields.

The invention is not therefore limited to the shown and described preferred embodiments, but extends generally to any embodiment which falls within the scope of the appended claims as seen in light of the foregoing description and drawings.

1. A fluid control valve to be inserted in a valve housing, said valve comprising a sealing element having a sealing surface and projecting in a radial direction for sealing one or more fluid openings in said valve housing, which sealing element is responsive to fluid pressure to open and close to control the fluid flow through the fluid openings, characterized in that, the sealing element is provided with at least one recess on the surface of the sealing element such that at least one sealing end is defined on the sealing element extending between the recess and the periphery of the sealing element, said sealing end including the sealing surface.

2. A fluid control valve according to claim 1, wherein the sealing end comprises a thickened part located adjacent the recess.

3. A fluid control valve according to claim 1, wherein the recess is substantially located in the center of the sealing element.

4. A fluid control valve according to claim 1, wherein the shape of the recess is essentially in conformance with the shape of the outer circumference of the sealing element.

5. A fluid control valve according to claim 1, wherein the recess is substantially disc-shaped.

6. A fluid control valve according to claim 1, wherein the recess is a groove, preferably forming an essentially closed loop.

7. A fluid control valve according to claim 6, wherein the groove has a substantially annular shape.

8. A fluid control valve according to claim 1, wherein the sealing element is provided with two or more recesses that are formed as grooves extending over the surface of the sealing element at a predetermined mutual distance.

9. A fluid control valve according to claim 1, wherein the sealing element is substantially disk-shaped.
